(19) United States
(12) Patent Application Publication
(10) Pub. No.: US 2024/0301244 A1
(43) Pub. Date: Sep. 12, 2024

(54) RESIN COMPOSITION, METHOD OF MANUFACTURING DISPLAY DEVICE, AND DISPLAY DEVICE

(71) Applicant: Samsung Display Co., LTD., Yongin-si (KR)

(72) Inventor: Keisuke MORITA, Yokohama (JP)

(21) Appl. No.: 18/591,884

(22) Filed: Feb. 29, 2024

(30) Foreign Application Priority Data
Mar. 3, 2023 (KR) 10-2023-0028720

(51) Int. Cl. C09J 4/06; B32B 7/12; C09J 5/00; C09J 133/06

(52) U.S. Cl. CPC C09J 4/06; B32B 7/12; C09J 5/00; C09J 133/068; B32B 2457/208; C09J 2433/00

(57) ABSTRACT

A resin composition includes a (meth)acrylate copolymer polymerized including first to third monomers, a urethane (meth)acrylate oligomer, a monofunctional (meth)acrylate monomer, and a photoinitiator. The (meth)acrylate copolymer has a weight-average molecular weight equal to or greater than about 1,000 grams per mole (g/mol) and less than 50,000 g/mol, the first monomer is represented by a predetermined formula structure, the second monomer includes at least one of an alkyl (meth)acrylate, a hydroxyalkyl (meth)acrylate, or an alkoxyalkyl (meth)acrylate, and the third monomer is an aliphatic cyclic (meth)acrylate.

This application claims priority to Korean Patent Application No. 10-2023-0028720, filed on Mar. 3, 2023, and all the benefits accruing therefrom under 35 U.S.C. § 119, the content of which in its entirety is herein incorporated by reference.

### BACKGROUND

### 1. Field

The disclosure herein relates to a resin composition, a method of manufacturing a display device, the method including preparing an adhesive member, and a display device manufactured thereby.

### 2. Description of the Related Art

Various display devices used in multimedia devices such as a television, a mobile phone, a tablet computer, a navigation device, and a game console are being developed. An adhesive resin used in an adhesive member applied to various types of display devices is desired to have excellent coating properties on members of various types of display devices.

### SUMMARY

When an adhesive resin is cured in the atmosphere including or consisting of oxygen in order to form the adhesive member, a curing inhibition phenomenon occurs, and adhesiveness is not sufficient, so that a method to solve this is desired.

The disclosure provides a resin composition capable of exhibiting excellent adhesiveness when cured in the atmosphere including or consisting of oxygen, and a method of manufacturing a display device including an adhesive member formed by the resin composition.

The disclosure also provides a display device including an adhesive member having excellent adhesive reliability at room temperature and a relatively high temperature.

An embodiment of the inventive concept provides a resin composition including a (meth)acrylate copolymer polymerized including first to third monomers, a urethane (meth)acrylate oligomer, a monofunctional (meth)acrylate monomer, and a photoinitiator. The (meth)acrylate copolymer has a weight-average molecular weight equal to or greater than about 1,000 grams per mole (g/mol) and less than 50,000 g/mol. The first monomer is represented by Formula 1 below, the second monomer includes at least one of an alkyl (meth)acrylate, a hydroxyalkyl (meth)acrylate, or an alkoxyalkyl (meth)acrylate, and the third monomer is an aliphatic cyclic (meth)acrylate.

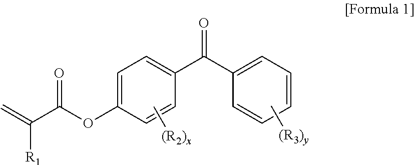

In Formula 1 above, R₁ is a hydrogen atom or a methyl group, R₂ and R₃ are each independently a hydrogen atom, an unsubstituted alkyl group having 1 to 18 carbon atoms, an unsubstituted alkoxy group having 1 to 12 carbon atoms, a hydroxyl group, a carboxyl group, or a halogen atom, x is an integer of 0 to 4, and γ is an integer of 0 to 5.

In an embodiment, in the resin composition, with respect to 100 parts by weight of the urethane (meth)acrylate oligomer, the monofunctional (meth)acrylate monomer, and the photoinitiator, the (meth)acrylate copolymer may be included in an amount of about 0.1 parts by weight to about 50 parts by weight.

In an embodiment, in the resin composition, the (meth)acrylate copolymer may include about 1 mole percent (mol %) to about 50 mol % of the first monomer in a polymerized form.

In an embodiment, in the resin composition, the urethane (meth)acrylate oligomer may have a weight-average molecular weight of about 5,000 grams per mole to about 100,000 grams per mole.

In an embodiment, the resin composition may have a peel strength of about 400 grams-force (gf) per(/) 25 millimeters (mm) or more at about 25 degrees Celsius (° C.) according to Japanese Industrial Standard (“JIS”) K6854 after photo-cured, and about 100 gf/25 mm or more at about 60° C.

In an embodiment, the resin composition may not include an organic solvent.

In an embodiment, in the resin composition, the (meth)acrylate copolymer may have a glass transition temperature of about 100° C.

In an embodiment, in the resin composition, the first monomer may be a 4-benzoylphenyl methacrylate.

In an embodiment of the inventive concept, a method of manufacturing a display device includes providing the above-described resin composition of an embodiment on a first substrate, irradiating the resin composition with ultraviolet light in the atmosphere to form an adhesive member, and providing a second substrate on the adhesive member.

In an embodiment of the inventive concept, a display device includes a display panel, a window disposed on the display panel, and an adhesive member disposed between the display panel and the window, wherein the adhesive member includes a polymer derived from the above-described resin composition of an embodiment.

### BRIEF DESCRIPTION OF THE DRAWINGS

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a perspective view illustrating a display device of an embodiment;

FIG. 2 is an exploded perspective view illustrating the display device of an embodiment;

FIG. 3 is a cross-sectional view illustrating a display device of an embodiment;

Each of FIGS. 4A to 4C is a view schematically illustrating an operation of manufacturing a display device of an embodiment;

FIG. 5 is a cross-sectional view illustrating a display device of an embodiment; and

FIG. 6 is a cross-sectional view illustrating a display device of an embodiment.

### DETAILED DESCRIPTION

The inventive concept may be modified in various manners and have many forms, and thus illustrative embodiments will be exemplified in the drawings and described in detail in the detailed description. It should be understood, however, that it is not intended to limit the inventive concept to the particular forms disclosed, but rather, is intended to cover all modifications, equivalents, and alternatives falling within the spirit and scope of the inventive concept.

In the specification, when a component (or a region, a layer, a portion, etc.) is referred to as being “on,” “connected to,” or “coupled to” another component, it means that the component may be directly disposed on/connected to/coupled to the other component, or that a third component may be disposed therebetween.

Like reference numerals refer to like components throughout. Also, in the drawings, the thicknesses, ratios, and dimensions of the components are exaggerated for effective description of technical contents. The term “and/or” includes all of one or more combinations that can be defined by associated items.

It will be understood that, although the terms “first,” “second,” etc. may be used herein to describe various components, these components should not be limited by these terms. These terms are only used to distinguish one component from another. For example, a first component could be termed a second component, and, similarly, a second component could be termed a first component, without departing from the scope of the inventive concept. The terms of a singular form may include plural forms unless the context clearly indicates otherwise.

In addition, terms such as “below,” “under,” “on,” and “above” may be used to describe the relationship between components illustrated in the drawing figures. The terms are used as a relative concept and are described with reference to the direction indicated in the drawings.

It should be understood that the terms “comprise,” or “have” are intended to specify the presence of stated features, integers, steps, operations, components, parts, or combinations thereof in the specification, but do not preclude the presence or addition of one or more other features, integers, steps, operations, components, parts, or combinations thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term “about” can mean within one or more standard deviations, or within ±30%, 20%, 10%, 5% of the stated value, for example.

Unless otherwise defined, all terms (including technical and scientific terms) used herein have the same meaning as commonly understood by one of ordinary skill in the art to which the inventive concept belongs. In addition, it will be understood that terms, such as those defined in commonly used dictionaries, should be interpreted as having a meaning that is consistent with their meaning in the context of the relevant art and will not be interpreted in an idealized or overly formal sense unless expressly so defined herein.

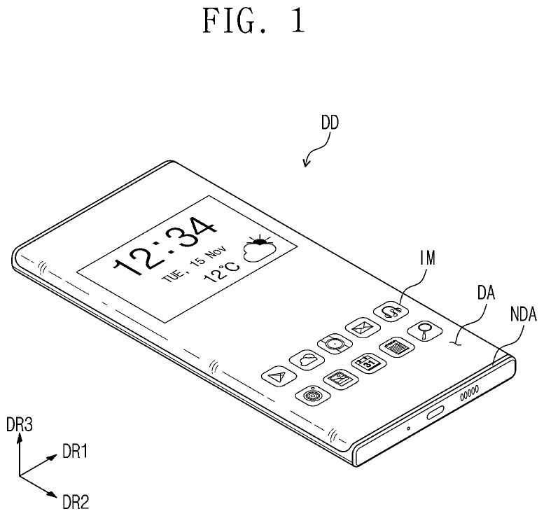

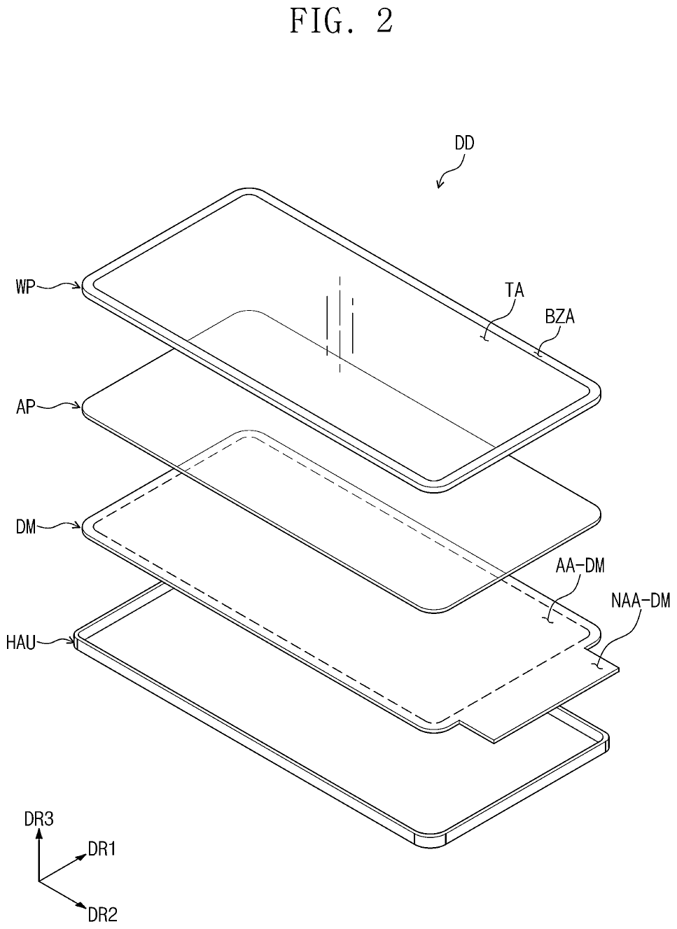

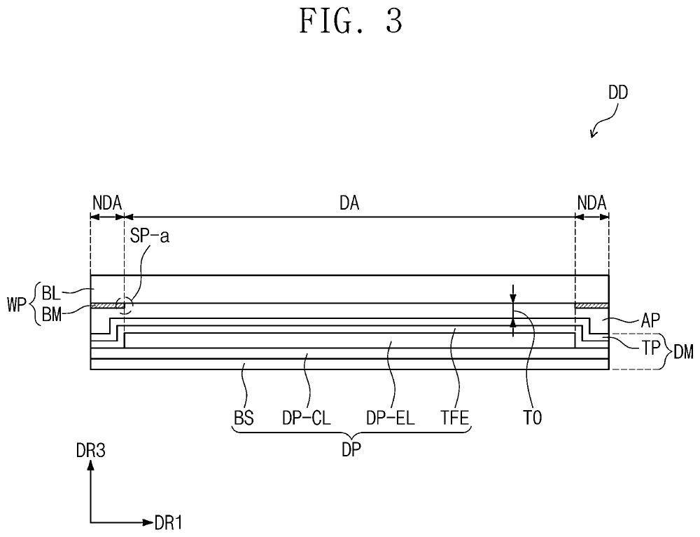

Hereinafter, an adhesive member of an embodiment of the inventive concept and a display device including the same will be described with reference to the accompanying drawings. FIG. 1 is a perspective view illustrating an embodiment of a display device. FIG. 2 is an exploded perspective view of an embodiment of the display device.

The display device DD of an embodiment illustrated in FIG. 1 may be activated by an electrical signal. In an embodiment, the display device DD may be a personal computer, a laptop computer, a personal digital terminal, a game console, a portable electronic device, a television, a monitor, an outdoor billboard, a car navigation device, or a wearable device, for example, but the inventive concept is not limited thereto. FIG. 1 illustrates that the display device DD is a mobile phone.

Referring to FIG. 1, the display device DD in an embodiment may display an image IM through a display region DA. The display region DA may include a plane defined by a first directional axis DR1 and a second directional axis DR2. The display device DD may display the image IM toward a third directional axis DR3 in a display region DA. The display region DA may include a curved surface bent from at least one side of a plane defined by the first directional axis DR1 and the second directional axis DR2. The display device DD of an embodiment illustrated in FIG. 1 is illustrated to include two curved surfaces respectively bent from both side surfaces of the plane defined by the first directional axis DR1 and the second directional axis DR2. However, the shape of the display region DA is not limited thereto. In an embodiment, the display region DA may include only the plane defined by the first directional axis DR1 and the second directional axis DR2, and the display region DA may further include four curved surfaces respectively bent from at least two sides, e.g., four sides of the plane defined by the first directional axis DR1 and the second directional axis DR2.

The display device DD of an embodiment may be flexible. The term of “flexible” means a characteristic capable of being curved, and may include all structures from being fully bent to being bent in several nanometers scale. In an embodiment, the display device DD may be a foldable display device, for example. Also, the display device DD may be rigid.

The non-display region NDA may be an area adjacent to the display region DA. The non-display region NDA may surround the display region DA. Thus, a shape of the display region DA may be substantially defined by the non-display region NDA. However, this is illustrated by way of example. In an embodiment, the non-display region NDA may be disposed adjacent to only one side of the display region DA or omitted, for example. The display region DA may be provided in various shapes, and is not limited to any particular embodiment.

FIG. 1 and the drawings below illustrate the first directional axis DR1 to third directional axis DR3, and the directions indicated by the first to third directional axes DR1, DR2 and DR3 described in this specification are relative concepts and may be converted into other directions. In addition, the directions indicated by the first to third directional axes DR1, DR2 and DR3 may be described as first to third directions, and the same reference symbols may be used. In this specification, the first direction axis DR1 and the second direction axis DR2 are orthogonal to each other, and the third direction axis DR3 may be a normal line direction with respect to the plane defined by the first direction axis DR1 and the second direction axis DR2.

The display device DD may have a thickness direction parallel to a third directional axis DR3 that is the normal direction with respect to a plane defined by the first directional axis DR1 and the second directional axis DR2. In this specification, a front surface (or a top surface, an upper surface, an upper portion) and a rear surface (or a bottom surface, a lower surface, a lower portion) of each member constituting the display device DD may be defined on the basis of the third directional axis DR3. In addition, in this specification, the direction in which the third directional axis DR3 is extended is parallel to a thickness direction, a front surface (or a top surface, an upper surface, an upper portion) means a surface (or direction) adjacent to the surface on which the image IM is displayed, and a rear surface (or a bottom surface, a lower surface, a lower portion) means a surface (or direction) spaced from the surface on which the image IM is displayed.

Referring to FIG. 2, the display device DD may include a display module DM, a window WP disposed on the display module DM, and an adhesive member AP disposed between the display module DM and the window WP. In addition, the display device DD may further include a housing HAU in which the display module DM is accommodated.

In the display device DD illustrated in FIGS. 1 and 2, the window WP and the housing HAU may be coupled to constitute the exterior of the display device DD. The housing HAU may be disposed on the lower portion of the display module DM. The housing HAU may include a material having a relatively higher rigidity. In an embodiment, the housing HAU may include a plurality of frames and/or plates including or consisting of glass, plastic, or metals, for example. The housing HAU may provide a predetermined accommodating space. The display module DM may be accommodated in the accommodating space and be protected from an external impact.

The display module DM may be activated in response to an electrical signal. The display module DM may be activated to display the image IM (refer to FIG. 1) in the display region DA (refer to FIG. 1) of the display device DD. An active region AA-DM and a peripheral region NAA-DM may be defined in the display module DM. The active region AA-DM may be a region which is activated in response to an electrical signal. The peripheral region NAA-DM may be a region that is disposed to be adjacent to at least one side of the active region AA-DM. A circuit or a wiring for driving the active region AA-DM may be disposed in the peripheral region NAA-DM.

The adhesive member AP may be formed from a resin composition of an embodiment. The adhesive member AP may include the polymer derived from the resin composition of an embodiment. The resin composition of an embodiment will be described later. The display module DM and the window WP may be coupled by the adhesive member AP. The adhesive member AP may exhibit excellent adhesive characteristics at room temperature, about 25 degrees Celsius (° C.), and a relatively high temperature of about 60° C.

The window WP may include a transmission region TA and a bezel region BZA. The front surface of the window WP including the transmission region TA and the bezel region BZA corresponds to the front surface of the display device DD. The transmission region TA may overlap at least a portion of the active region AA-DM of the display module DM. The transmission region TA may be an optically clear region. The image IM (refer to FIG. 1) may be provided to a user through the transmission region TA.

The bezel region BZA may have a light transmittance relatively lower than the transmission region TA. The bezel region BZA may define the shape of the transmission region TA. The bezel region BZA may be adjacent to the transmission region TA, and may surround the transmission region TA.

The bezel region BZA may have a predetermined color. The bezel region BZA may cover a peripheral region NAA-DM of the display module DM to prevent the peripheral region NAA-DM from being viewed from the outside. However, the inventive concept is not limited to the configuration illustrated, the bezel region BZA may be disposed adjacent to only one side of the transmission region TA, and at least a part thereof may be omitted.

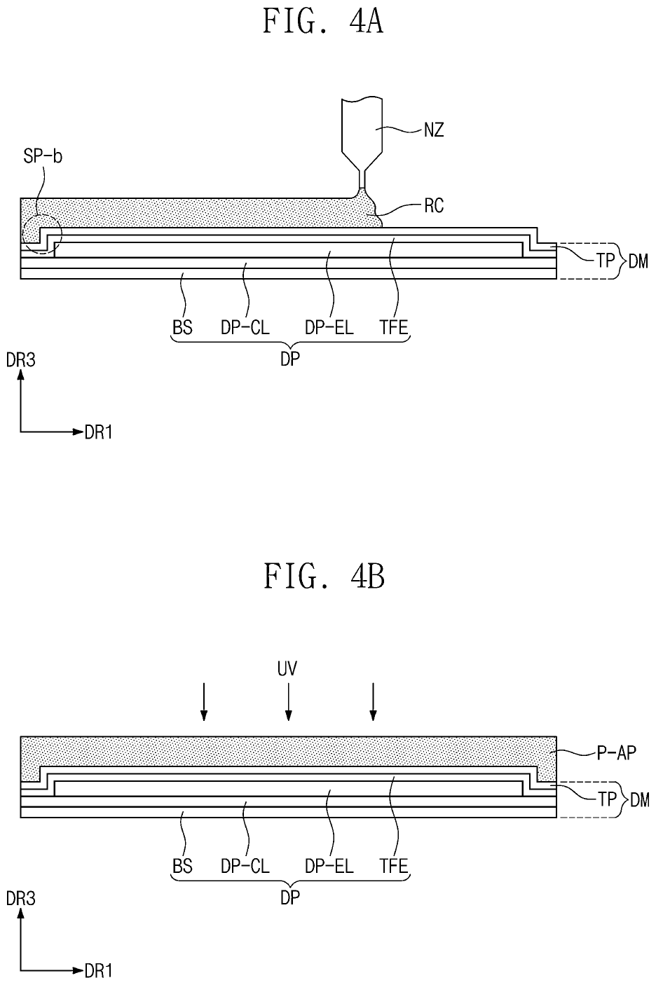

FIG. 3 is a cross-sectional view illustrating a display device DD of an embodiment. In FIG. 3, the housing HAU in FIG. 2 is omitted, and a display module DM, an adhesive member AP, and a window WP are illustrated.

Referring to FIG. 3, the display module DM may include a display panel DP and an input sensing unit TP disposed on the display panel DP. The display panel DP may include a base substrate BS, a circuit layer DP-CL disposed on the base substrate BS, a display element layer DP-EL disposed on the circuit layer DP-CL, and an encapsulation layer TFE covering the display element layer DP-EL. The display device DD of an embodiment may include an adhesive member AP disposed between the display panel DP and the window WP. In an embodiment, in the display device DD of an embodiment, the adhesive member AP may be disposed between the input sensing unit TP and the window WP, for example. The adhesive member AP may be an optically clear adhesive resin layer (“OCR”).

The configuration of the display panel DP illustrated in FIG. 3, etc. is exemplary, and the configuration of the display panel DP is not limited thereto. In an embodiment, the display panel DP may include a liquid crystal display element, and in this case, the encapsulation layer TFE may be omitted, for example.

The base substrate BS may provide a base surface on which the circuit layer DP-CL is disposed. The base substrate BS may be a flexible substrate which is bendable, foldable, or rollable. The base substrate BS may be a glass substrate, a metal substrate, or a polymer substrate. However, the disclosure is not limited thereto, and the base substrate BS may be an inorganic layer, an organic layer, or a composite material layer.

The circuit layer DP-CL may include an insulation layer, a semiconductor pattern, a conductive pattern, a signal line, etc. In an embodiment, the circuit layer DP-CL may include a switching transistor and a driving transistor for driving the light-emitting element (not shown) of the display element layer DP-EL, for example.

The display element layer DP-EL may include the light-emitting element (not shown) which emits light. In an embodiment, the light-emitting element (not shown) may include an organic light-emitting material, an inorganic light-emitting material, an organic-inorganic light-emitting material, quantum dots, quantum rods, a micro LED, or a nano LED, for example.

The encapsulation layer TFE may be disposed on the upper portion of the display element layer DP-EL. The encapsulation layer TFE may protect the display element layer DP-EL from foreign substances such as moisture, oxygen, and/or the dust particles. The encapsulation layer TFE may include at least one inorganic layer. In addition, the encapsulation layer TFE may include at least one organic layer and at least one inorganic layer. In an embodiment, the encapsulation layer TFE may include an inorganic layer, an organic layer, and an inorganic layer, which are sequentially stacked, for example.

The input sensing unit TP may be disposed on the display panel DP. In an embodiment, the input sensing unit TP may be directly disposed on the encapsulation layer TFE of the display panel DP, for example. The input sensing unit TP may detect an external input, convert the external input to a predetermined input signal, and provide the input signal for the display panel DP. In an embodiment, in the display device DD of an embodiment, the input sensing unit TP may be a touch sensing unit that senses a touch, for example. The input sensing unit TP may recognize a user's direct touch, a user's indirect touch, a direct touch of an object, or an indirect touch of an object.

The input sensing unit TP may sense at least one of a location or force (pressure) of the externally applied touch. The input sensing unit TP may have various structures or may include or consist of various materials, and is not limited to any particular embodiment. The input sensing unit TP may include a plurality of sensing electrodes (not shown) so as to sense an external input. The sensing electrodes (not shown) may sense the external input in a capacitive manner. The display panel DP may receive an input signal from the input sensing unit TP, and generate an image corresponding to the input signal.

The window WP may protect the display panel DP, the input sensing unit TP, or the like. The image IM (refer to FIG. 1) generated in the display panel DP may be transmitted through the window WP to be provided to a user. The window WP may provide a touch surface of the display device DD.

The window WP may include a base layer BL and a printing layer BM. Although not illustrated, the window WP may further include at least one functional layer (not shown) provided on the base layer BL. In an embodiment, the functional layer (not shown) may be a hard coating layer, an anti-fingerprint coating layer, or the like, for example, but the inventive concept is not limited thereto.

The base layer BL may be a glass substrate or plastic substrate. In an embodiment, a tempered glass substrate may be used as the base layer BL in the window WP of an embodiment, for example. In an alternative embodiment, the base layer BL may include or consist of a flexible polymer resin. In an embodiment, the base layer BL may include or consist of polyimide, polyacrylate, polymethylmethacrylate, polycarbonate, polyethylenenaphthalate, polyvinylidene chloride, polyvinylidene difluoride, polystyrene, ethylene-vinyl alcohol copolymer, or any combinations thereof, for example.

The printing layer BM may be disposed on one surface of the base layer BL. The printing layer BM may be provided on the bottom surface of the base layer BL adjacent to the display module DM. The printing layer BM may be disposed on an edge area of the base layer BL. The printing layer BM may be an ink printing layer. In addition, the printing layer BM may be a layer including a pigment or a dye. In the window WP, the bezel region BZA may be a portion in which the printing layer BM is provided.

The adhesive member AP may be disposed under the window WP. In the window WP, a step SP-a may be provided between the printing layer BM and the base layer BL on which the printing layer BM is not provided. The adhesive member AP, which is formed from the resin composition in an embodiment, has relatively good flexibility and relatively high adhesive strength, and thus may adhere to the window WP at the step SP-a without delamination.

The resin composition of an embodiment may include a (meth)acrylate copolymer, a urethane (meth)acrylate oligomer, a monofunctional (meth)acrylate monomer, and a photoinitiator. In the specification, the (meth)acrylate may mean acrylate and/or methacrylate.

The (meth)acrylate copolymer may be the one polymerized including a first monomer, a second monomer, and a third monomer. The (meth)acrylate copolymer may be the one polymerized from a monomer mixture including the first monomer, the second monomer, and the third monomer. Accordingly, the (meth)acrylate copolymer may include a first repeating unit derived from the first monomer, a second repeating unit derived from the second monomer, and a third repeating unit derived from the third monomer.

The first monomer may be the (meth)acrylate including or consisting of a benzophenone moiety. The resin composition of an embodiment includes a (meth)acrylate copolymer, and this (meth)acrylate copolymer includes or consists of the first repeating unit derived from the first monomer, so that the (meth)acrylate copolymer may form a crosslinking structure with a matrix in the resin composition through the hydrogen withdrawing reaction by the benzophenone moiety in the (meth)acrylate copolymer during the photo-curing, thereby providing excellent adhesiveness. In an embodiment, the first monomer may be represented by Formula 1 below, for example:

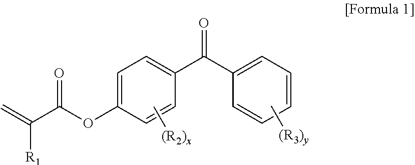

In Formula 1, R₁ may be a hydrogen atom or a methyl group. R₂ and R₃ may be each independently a hydrogen atom, an unsubstituted alkyl group having 1 to 18 carbon atoms, an unsubstituted alkoxy group having 1 to 12 carbon atoms, a hydroxyl group, a carboxyl group, or a halogen atom.

In Formula 1, x may be an integer of 0 to 4, and y may be an integer of 0 to 5. In Formula 1, when each of x and y is 0, Formula 1 may not be substituted with each of R₂ and R₃. Therefore, in Formula 1, when x is 0, the first monomer of an embodiment may not be substituted with R₂. In addition, when y is 0, the first monomer of an embodiment may not be substituted with R₃. In Formula 1, the case where x is 4 and four Res are all hydrogen atoms may be the same as the case where x is 0. When x is an integer of 2 or greater, a plurality of R₂s may all be the same, or at least one of the plurality of R₂s may be different from the others. The case where y is 5 and five R₃s are all hydrogen atoms may be the same as the case where y is 0. When y is an integer of 2 or greater, a plurality of R₃s may all be the same, or at least one of the plurality of R₃s may be different from the others.

In an embodiment, R₁ in Formula 1 is a methyl group, and each of R₂ and R₃ may be a hydrogen atom. That is, the first monomer may be 4-benzoylphenyl methacrylate, for example, but the inventive concept is not limited thereto. The first monomer may be 4-benzoylphenyl-4′-methyl-benzophenyl, 4-benzoylphenyl-2′-methyl-benzophenyl, etc.

In an embodiment, the first monomer may have a copolymerization ratio of about 0.1 mole percent (mol %) to about 50 mol % with respect to the whole. In an embodiment, the (meth)acrylate copolymer may include about 1 mol % to about 50 mol % of the first monomer in a polymerized form, for example. That is, with respect to 100 mol % of the (meth)acrylate copolymer, the amount of the first repeating unit derived from the first monomer may be about 1 mol % to about 50 mol %. The resin composition of an embodiment may suppress the deterioration of the surface curing due to oxygen during photo-curing in the atmosphere by including the (meth)acrylate copolymer in which the first monomer is polymerized in the above amount, and may exhibit excellent tackiness and adhesiveness at room temperature and a relatively high temperature.

The second monomer may include at least one of an alkyl (meth)acrylate, a hydroxyalkyl (meth)acrylate, or an alkoxyalkyl (meth)acrylate.

In an embodiment, the alkyl (meth)acrylate may be a (meth)acrylate having an alkyl group, for example. The alkyl (meth)acrylate may be a (meth)acrylate including or consisting of an unsubstituted alkyl group having 1 to 18 carbon atoms. In an embodiment, the alkyl (meth)acrylate may include at least one of a methyl (meth)acrylate, an ethyl (meth)acrylate, a propyl (meth)acrylate, an n-butyl (meth)acrylate, a t-butyl (meth)acrylate, an iso-butyl (meth)acrylate, a pentyl (meth)acrylate, a hexyl (meth)acrylate, a heptyl (meth)acrylate, an octyl (meth)acrylate, a nonyl (meth)acrylate, or a decyl (meth)acrylate, for example.

The hydroxyalkyl (meth)acrylate may be an alkyl (meth)acrylate having a hydroxy group. In an embodiment, the alkyl (meth)acrylate having a hydroxy group may be —(CH₂)ₙ—OH, wherein n may be a natural number, for example. The hydroxyalkyl (meth)acrylate may be a C1-C15 alkyl (meth)acrylate having at least one hydroxy group. In an embodiment, the hydroxyalkyl (meth)acrylate may include at least one of 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 6-hydroxyhexyl (meth)acrylate, or 8-hydroxyoctyl (meth)acrylate, for example.

The alkoxyalkyl (meth)acrylate may be an alkyl (meth)acrylate having an alkoxy group. The alkoxyalkyl (meth)acrylate may be an alkyl (meth)acrylate including or consisting of an alkoxy group having 1 to 10 carbon atoms. In an embodiment, the alkoxyalkyl (meth)acrylate may be methoxymethyl (meth)acrylate, methoxyethyl (meth)acrylate, methoxypropyl (meth)acrylate, methoxybutyl (meth)acrylate, ethoxymethyl (meth)acrylate, ethoxyethyl (meth)acrylate, ethoxypropyl (meth)acrylate, ethoxybutyl (meth)acrylate, methoxydiethylene glycol (meth)acrylate, ethoxydiethylene glycol (meth)acrylate, methoxytriethylene glycol (meth)acrylate, ethoxytriethylene glycol(meth)acrylate, or the like, for example, but the inventive concept is not limited thereto.

The third monomer may be an aliphatic cyclic (meth)acrylate. The aliphatic cyclic (meth)acrylate may be a (meth)acrylate including or consisting of a substituted or unsubstituted cycloalkyl group having 3 to 20 carbon atoms. In an embodiment, the aliphatic cyclic (meth)acrylate may include at least one of cyclohexyl (meth)acrylate, isobornyl (meth)acrylate, 3,3,5-trimethylcyclohexylacrylate, or dicyclopentanyl (meth)acrylate, for example.

The resin composition of an embodiment of the invention may suppress the deterioration of curing on the surface of the resin composition applied on the substrate even when photo-curing is performed in the presence of oxygen due to including the above-described (meth)acrylate copolymer, thereby exhibiting excellent tackiness/adhesiveness. In addition, the resin composition of an embodiment may exhibit excellent tackiness/adhesiveness not only at room temperature but also at a relatively high temperature during photo-curing.

The (meth)acrylate copolymer may have a weight-average molecular weight (Mw) of about 1,000 g/mol to about 50,000 g/mol (exclusive of 50,000 g/mol, i.e., less than 50,000 g/mol), about 1,000 g/mol to about 48,000 g/mol, or about 1,000 g/mol to about 20,000 g/mol. When the weight-average molecular weight of the (meth)acrylate copolymer has the above-described range, the resin composition of the embodiment including the (meth)acrylate copolymer may exhibit excellent adhesiveness at room temperature and a relatively high temperature during curing. When the weight-average molecular weight of the (meth)acrylate copolymer is less than about 1,000 g/mol, it may be difficult to separate and purify the (meth)acrylate copolymer. In addition, when the weight-average molecular weight of the (meth)acrylate copolymer is about 50,000 g/mol or more, the solubility and adhesiveness may be deteriorated.

The resin composition of an embodiment may include about 0.1 parts by weight to about 50 parts by weight of the (meth)acrylate copolymer with respect to 100 parts by weight of a urethane (meth)acrylate oligomer, a monofunctional (meth)acrylate monomer, and a photoinitiator which will be described later. The resin composition of an embodiment may include the (meth)acrylate copolymer in the above-described content range to exhibit excellent peel strength characteristics after the curing of the resin composition.

In an embodiment, the glass transition temperature (Tg) of the (meth)acrylate copolymer may be about 100° C. or higher. In this case, the (meth)acrylate copolymer may have optimized cohesiveness when the resin composition is photo-cured, and thus the adhesiveness of the adhesive member AP formed from the resin composition may be improved.

The resin composition of an embodiment may include a urethane (meth)acrylate oligomer. The resin composition may include at least one urethane (meth)acrylate oligomer.

The urethane (meth)acrylate oligomer may include a photocurable compound including at least one (meth)acryloyl group having a urethane bond. The urethane (meth)acrylate oligomer may include at least one of an acrylate having a urethane bond, a urethane acrylate having a polycarbonate backbone, a urethane acrylate having a polyester backbone, or a urethane acrylate having a polyether backbone.

In an embodiment, the urethane (meth)acrylate oligomer may have a weight-average molecular weight (Mw) of about 5,000 g/mol to about 100,000 g/mol (exclusive of 100,000 g/mol, i.e., less than 100,000 g/mol). The urethane (meth)acrylate oligomer having a weight-average molecular weight within the above-described range is included in the resin composition in an oligomer state having a relatively high degree of polymerization, and thus it is possible to maintain a relatively high degree of polymerization even after photo-curing. Accordingly, the adhesive member AP formed from the resin composition of an embodiment may exhibit excellent adhesion.

In an embodiment, the resin composition of an embodiment may include, as a urethane (meth)acrylate oligomer, at least one of UF-C051 (manufactured by Kyoeisha Chemical Co., Ltd.) and UN-6304 (manufactured by Negami Chemical Industrial Co., Ltd.), for example. However, this is merely one of embodiments, and the inventive concept is not limited thereto.

In an embodiment, the resin composition including the urethane (meth)acrylate oligomer may exhibit relatively low viscosity characteristics which allows to be applied by means of a method, such as a bar-coating method, an inkjet printing method, or a dispensing coating method. Accordingly, the resin composition of an embodiment may be applied on the substrate in a uniform amount and a uniform thickness, and the adhesive member AP formed from the resin composition may exhibit excellent adhesive reliability.

The resin composition of an embodiment may include a monofunctional (meth)acrylate monomer. The monofunctional (meth)acrylate monomer may include a plurality of different monomers. In an embodiment, in the resin composition of an embodiment, the monofunctional (meth)acrylate monomer may include at least one monofunctional acrylate monomer and at least one monofunctional methacrylate monomer, for example.

The monofunctional (meth)acrylate monomer may include at least one of 2-ethylhexyl acrylate, 4-hydroxy butyl acrylate, isodecyl acrylate, 2-methyl-2-ethyl-1,3-dioxolane-4-ylmethyl acrylate, or butyl acrylate.

The resin composition of an embodiment is a photocurable resin composition, and may include a photoinitiator. Any photoinitiator may be used without particular limitation as long as it may induce a polymerization reaction of a radical polymerizable compound during a curing process by means of ultraviolet light irradiation. In an embodiment, a radical polymerization initiator such as benzoin-based, hydroxy ketone-based, aminoketone-based, or phosphine oxide-based may be used as the photoinitiator, for example.

In an embodiment, the photoinitiator may include at least one of 2,2-dimethoxy-1,2-diphenylethan-1-one, 1-hydroxy cyclohexyl-phenylketone, 2-hydroxy-2-methyl-1-phenyl-1-propanone, 2-hydroxy-1-[4-(2-hydroxyethoxy)phenyl]-2-methyl-1-propanone, or 2-hydroxy-1-{4-[4-(2-hydroxy-2-methyl-propionyl)-benzyl]-phenyl}-2-methylpropan-1-one, for example.

In addition, the photoinitiator may include at least one of 2-methyl-1[4-(methylthio)phenyl]-2-morpholinopropan-1-one, 2-benzyl-2-dimethylamino-1-(4-morpholinophenyl)-butanone-1, 2-dimethylamino-2-(4-methyl-benzyl)-1-(4-morpholin-4-yl-phenyl)-butan-1-one, 2,4,6-trimethylbenzoyl-diphenylphosphine oxide, ethyl(2,4,6-trimethylbenzoyl)phenyl phosphinate, phenylbis(2,4,6-trimethylbenzoyl)phosphine oxide, [1-(4-phenylsulfanylbenzoyl)heptylideneamino]benzoate, [1-[9-ethyl-6-(2-methylbenzoyl)carbazol-3-yl]ethylideneamino] acetate, or bis(2,4-cyclopentadienyl)bis[2,6-difluoro-3-(1-pyrryl)phenyl] titanium(IV). In addition, the resin composition RC may include, as a photoinitiator, at least one of Omnirad 819 (IGM Resins, Inc.), or Omnirad 184 (IGM Resins, Inc.). Omnirad 819 (IGM Resins, Inc.) and Omnirad 184 (IGM Resins, Inc.) are radical polymerization initiators.

The resin composition of an embodiment may not substantially include an organic solvent. That is, the resin composition of an embodiment may be a solvent-free type. In an embodiment, when a solvent-free type resin composition is used to form the adhesive member AP, a process for drying an organic solvent may be omitted, thereby improving production efficiency.

The adhesive member AP included in the display device of an embodiment may be formed by providing the resin composition on one surface of the window WP or the display module DM and then irradiating, with ultraviolet light, the resin composition provided on one surface of the window WP or the display module DM in the atmosphere and curing. However, the inventive concept is not limited thereto. In an embodiment, the adhesive member AP may be provided in a method in which the adhesive member AP is formed by curing the resin composition of an embodiment with ultraviolet light in a separate process, one surface of the adhesive member AP cured in the form of an adhesive film is laminated on one surface of the window WP or the display module DM, and one unattached surface of the window WP or the display module DM is attached on the other surface of the adhesive member AP, for example.

In an embodiment, the thickness TO of the adhesive member AP may be about 50 micrometers (μm) to about 200 μm. In an embodiment, the adhesive member AP may have a thickness TO of about 50 μm to about 100 μm, for example. However, this is merely one of embodiments, and the thickness TO of the adhesive member AP is not limited thereto.

In an embodiment, the adhesive member AP may have a peel strength (180° peel strength) in a 180° direction of about 400 grams-force (gf)/25 millimeters (mm) or more, or about 100 gf/25 mm or more. In an embodiment, the adhesive member AP may have a 180° peel strength of about 400 gf/25 mm or more at about 25° C., for example. In addition, the adhesive member AP may have a 180° peel strength of about 100 gf/25 mm or more at about 60° C.

In the specification, the peel strength of the adhesive member AP is a value measured for a cured product including or consisting of the resin composition of an embodiment. In an embodiment, the peel strength of the adhesive member AP may be measured by a specimen for measuring a peel strength, the specimen being prepared by applying the resin composition of an embodiment on a glass substrate (e.g., soda lime glass) and photo-curing to form a cured product, and laminating a polyethylene terephthalate (“PET”) film on the cured product, for example. Here, the cured product may correspond to the adhesive member AP of an embodiment. The peel strength of the adhesive member AP is a value measured when the adhesive layer and the polyethylene terephthalate film are peeled off from the glass substrate at a peel temperature of room temperature and a relatively high temperature and a peel angle of 180° according to Japanese Industrial Standard (“JIS”) K 6854. In the specification, the room temperature may be a temperature of about 25° C., and the relatively high temperature may be a temperature of about 60° C.

The adhesive member AP of an embodiment may have a 180° peel strength of about 400 gf/25 mm or more at room temperature and a 180° peel strength of about 100 gf/25 mm or more at a relatively high temperature, thereby exhibiting excellent adhesive reliability. Accordingly, the display device DD including the adhesive member AP of an embodiment may exhibit excellent reliability because a delamination phenomenon does not occur at the interface of the adhesive member AP.

The display device DD of an embodiment may be formed by a method of manufacturing a display device of an embodiment. In the method of manufacturing a display device of an embodiment, the adhesive member may be formed from the resin composition of an embodiment as described above. The method of manufacturing a display device of an embodiment may include providing a resin composition on a first substrate, forming an adhesive member by curing the resin composition, and disposing a second substrate on the adhesive member. In an embodiment, one of the first substrate or the second substrate may be the display module DM (refer to FIG. 3), and the rest other than the display module DM (refer to FIG. 3) may be the window WP (refer to FIG. 3).

FIGS. 4A to 4C schematically illustrate some operations of the method of manufacturing a display device according to the inventive concept. FIG. 4A illustrates providing a resin composition for forming an adhesive member on a first substrate. FIG. 4B illustrates irradiating, with ultraviolet light, a preliminary adhesive member formed from the resin composition, and FIG. 4C illustrates disposing the second substrate on the adhesive member formed from the resin composition. Hereinafter, in describing the method of manufacturing a display device of an embodiment with reference to FIGS. 4A to 4C, the duplicated features which have been described with reference to FIGS. 1 to 3 are not described again, but their differences will be mainly described.

The first substrate is a member on which a resin composition RC is provided, and FIG. 4A illustrates that the resin composition RC is provided on one surface of the display module DM. The providing of the resin composition RC may include forming a preliminary adhesive member P-AP from the resin composition RC provided on one surface of the display module DM to laminate the preliminary adhesive member P-AP on the display module DM. In this case, the second substrate may be the window WP.

Unlike the configuration illustrated in FIG. 4A, the resin composition RC may be provided on one surface of the window WP. The preliminary adhesive member P-AP may be formed from the resin composition RC provided on one surface of the window WP. In this case, the second substrate may be the display module DM.

In some embodiments, the resin composition RC may be provided on a separate substrate (e.g., a carrier substrate). When the resin composition RC is provided on a separate substrate to form the preliminary adhesive member P-AP, the separate substrate may be subjected to a release treatment on the surface to which the resin composition RC is applied.

The resin composition RC may be provided by a method such as a bar-coating method, an inkjet printing method, or a dispensing method. The resin composition RC of an embodiment may have a viscosity value at about 25° C. of about 1.0 megapascal second (mPa·s) to about 50 mPa·s, and thus, may be easily discharged from the nozzle NZ or the like, and may be provided to maintain a thin and constant coating thickness. In addition, the resin composition has a viscosity value of about 1.0 mPa·s to about 50 mPa·s, and thus may be provided to cover the curvature of the stepped portion SP-b of the display module DM. That is, since the resin composition has a relatively low viscosity value of about 50 mPa·s or less, the resin composition RC may be filled without an empty space in a curved portion such as the stepped portion SP-b. In addition, the resin composition RC provided through the nozzle NZ may have a viscosity value of about 1.0 mPa·s or more, so that the resin composition RC may be uniformly coated to a predetermined thickness without flowing out of the display module DM. The resin composition RC uniformly coated on the display module DM may form the preliminary adhesive member P-AP (refer to FIG. 4B).

The method of manufacturing a display device of an embodiment may not include the drying of the resin composition RC. The resin composition RC of an embodiment may be a solvent-free type resin composition that does not substantially include an organic solvent, and thus, after being applied onto the first substrate, a drying process may not be desired. Accordingly, the method of manufacturing a display device of an embodiment may exhibit excellent manufacture efficiency.

Referring to FIGS. 4A and 4B, the preliminary adhesive member P-AP formed by coating the resin composition RC with a uniform thickness may be cured by light. In an embodiment, the ultraviolet light UV may be provided to the preliminary adhesive member P-AP before the window WP is disposed on the preliminary adhesive member P-AP, for example. When the ultraviolet light UV is provided to the preliminary adhesive member P-AP, the polymerization reaction may be performed in the resin composition RC forming the preliminary adhesive member P-AP. The preliminary adhesive member P-AP may be polymerized and then cured by the irradiated ultraviolet light UV to form a cured product. The cured product may correspond to the adhesive member AP of an embodiment.

In an embodiment, the curing of the preliminary adhesive member P-AP, that is, the resin composition RC, may be performed in the atmosphere. In the inventive concept, the adhesive member AP (refer to FIG. 3) is formed from the resin composition RC of an embodiment, and thus even when oxygen is in the atmosphere, the deterioration of the radical polymerization reaction on the surface of the resin composition RC applied on the first substrate is suppressed, thereby exhibiting excellent curing characteristics. In an embodiment, since the (meth)acrylate copolymer included in the resin composition RC is segregated on the outermost surface side when the resin composition RC is cured, excellent adhesiveness of the adhesive member AP may be secured by a predetermined cohesive force, for example.

Accordingly, in the method of manufacturing a display device of an embodiment, the resin composition RC may be completely cured by only irradiating the resin composition RC with ultraviolet light UV once, and thus the process steps may be reduced, and an increase in equipment for blocking oxygen may not be desired. That is, in the method of manufacturing a display device of an embodiment, manufacturing costs may be reduced and manufacture efficiency may be improved.

However, the inventive concept is not limited thereto, when desired, the final adhesive member AP may be formed by partially performing the polymerization reaction of the resin composition RC in the preliminary adhesive member P-AP state, and then further reacting an unreacted resin composition RC with the ultraviolet light UV after the preliminary adhesive member P-AP is covered with the window WP.

In some embodiments, unlike the configuration illustrated in FIG. 4B, the resin composition RC may be coated on the display module DM to a predetermined thickness to form the preliminary adhesive member P-AP, and after the window WP may be provided on the preliminary adhesive member P-AP, and the ultraviolet light UV for curing the resin composition RC may be provided. In this case, the ultraviolet light UV may be provided through the window WP. In an embodiment, the amount of the ultraviolet light UV irradiated to the preliminary adhesive member P-AP may be an amount of light that completely cures the resin composition RC, for example. In an embodiment, the resin composition RC may be cured by the irradiation of the ultraviolet light UV in a wavelength region of about 365 nanometers (nm) at about 1,000 millijoules per square centimeter (mJ/cm²), for example.

According to the invention, the adhesive member AP may be formed after the curing with the ultraviolet light UV. The adhesive member AP prepared by the operations described with reference to FIGS. 4A and 4B may be applied to the above-described display device DD, and the adhesive member AP of an embodiment may exhibit excellent adhesion at room temperature and a relatively high temperature.

Referring to FIG. 4C, the method of manufacturing a display device of an embodiment may include disposing and bonding the window WP on the adhesive member AP. In an embodiment, one surface of the adhesive member AP may be attached on the display module DM, and then the window WP may be sequentially attached on the other surface of the adhesive member AP which faces one surface of the adhesive member AP attached to the display module DM. In an embodiment, according to the method of manufacturing a display device of an embodiment, after the window WP is provided on the adhesive member AP, the window WP may be bonded to the adhesive member AP by a lamination method under normal pressure, for example.

In addition, unlike the one above, the adhesive member AP may be provided to the display device DD by attaching one surface of the adhesive member AP on one surface of the window WP to face the display module DM, and then attaching, to the display module DM, the other surface of the adhesive member AP which faces one surface of the adhesive member AP attached to the window WP.

The display device DD of an embodiment manufactured through the operations described with reference to FIGS. 4A to 4C may include the adhesive member AP including the polymer derived from the above-described resin composition of an embodiment, and may maintain the adhesive state between the window WP and the display module DM by the adhesive member AP without delamination.

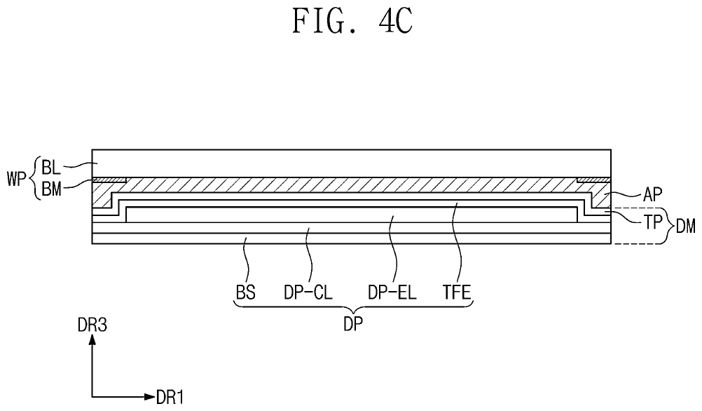

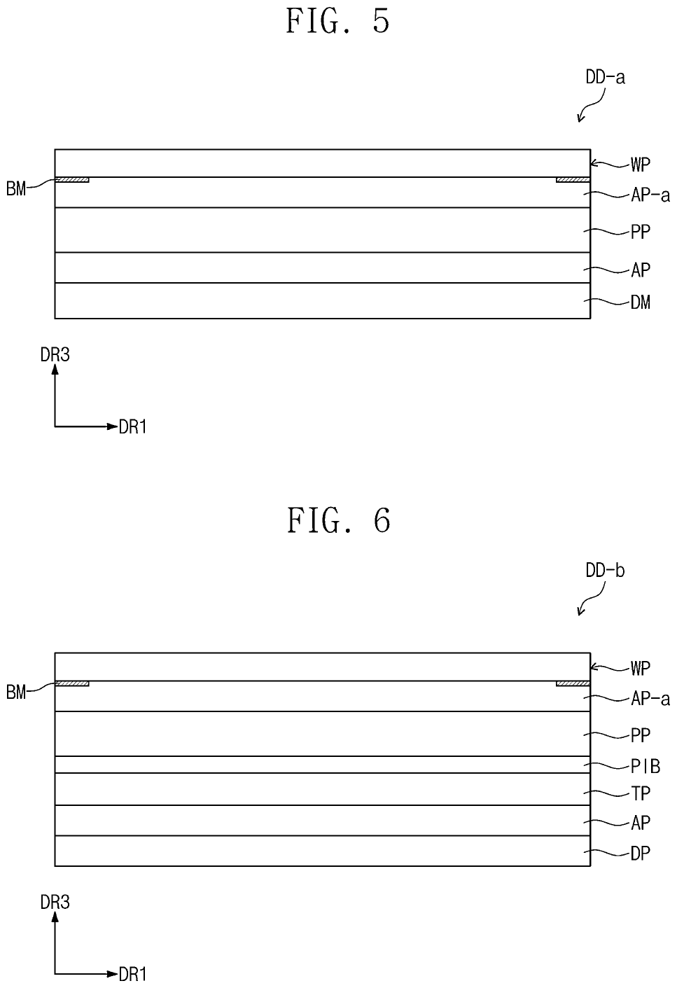

FIG. 5 is a cross-sectional view illustrating a display device. Hereinafter, in describing the display device illustrated in FIG. 6, the duplicated features which have been described with reference to FIGS. 1 to 4C are not described again, but their differences will be mainly described.

The display device DD-a illustrated in FIG. 5 may further include a light control layer PP and an optical adhesive layer AP-a as compared with the display device DD described with reference to FIGS. 2 and 3. The display device DD-a of an embodiment may further include the light control layer PP disposed between the adhesive member AP and the window WP, and the optical adhesive layer AP-a disposed between the light control layer PP and the window WP.

The light control layer PP may be disposed on a display panel DP to control reflected light in the display panel DP due to external light. The light control layer PP may include a polarization plate or a color filter layer, for example.

The optical adhesive layer AP-a may be an optically clear adhesive resin layer (“OCR”). In addition, the optical adhesive layer AP-a may be an optically clear adhesive layer (“OCA”). The optical adhesive layer AP-a may be formed from the above-described resin composition. The optical adhesive layer AP-a formed from the resin composition of an embodiment may have a 180° peel strength of about 400 gf/25 mm or more at room temperature, and may have a 180° peel strength of about 100 gf/25 mm or more at a relatively high temperature. The display device DD-a including the optical adhesive layer AP-a may exhibit excellent reliability. The optical adhesive layer AP-a of an embodiment may exhibit relatively high adhesion. The display device DD-a of an embodiment includes the optical adhesive layer AP-a and the adhesive member AP formed from the resin composition of an embodiment. The optical adhesive layer AP-a and the adhesive member AP have relatively high adhesion, and thus the display device DD-a may exhibit excellent reliability characteristics since the delamination phenomenon does not occur at the interface between the optical adhesive layer AP-a and the adhesive member AP at room temperature and a relatively high temperature.

FIG. 6 is a cross-sectional view illustrating a display device of an embodiment. Hereinafter, in describing the display device of an embodiment illustrated in FIG. 7, the duplicated features which have been described with reference to FIGS. 1 to 5 are not described again, but their differences will be mainly described.

The display device DD-b of an embodiment illustrated in FIG. 6 may further include a light control layer PP, an optical adhesive layer AP-a, and an inter-adhesive layer PIB as compared with the display device DD described with reference to FIGS. 2 and 3. The display device DD-b of an embodiment illustrated in FIG. 6 may further include the light control layer PP disposed between an adhesive member AP and a window WP, and the optical adhesive layer AP-a disposed between the light control layer PP and the window WP like the display device DD-a of an embodiment illustrated in FIG. 5.

In the display device DD-b of an embodiment, the adhesive member AP may be provided between a display panel DP and an input sensing unit TP. That is, the input sensing unit TP may not be disposed directly on the display panel DP, and the display panel DP and the input sensing unit TP may be coupled to each other via the adhesive member AP. In an embodiment, the adhesive member AP and may be disposed between the encapsulation layer TFE (refer to FIG. 3) of the display panel DP and the input sensing unit TP, for example.

The inter-adhesive layer PIB may be provided to the bottom side of the light control layer PP. The inter-adhesive layer PIB may be disposed between the input sensing unit TP and the light control layer PP, and include or consist of an adhesive material having superior anti-moisture permeability. In an embodiment, the inter-adhesive layer PIB may include polyisobutylene. The inter-adhesive layer PIB may be disposed on the input sensing unit TP to prevent corrosion of sensing electrodes of the input sensing unit TP. The display device DD-b of an embodiment includes the optical adhesive layer AP-a and the adhesive member AP formed from the resin composition RC. Accordingly, the display device DD-b of an embodiment may exhibit excellent reliability.

Hereinafter, with reference to Examples and Comparative Examples, an adhesive member and a display device formed from a resin composition in an embodiment of the inventive concept will be described in detail. In addition, Examples described below are only illustrations to assist the understanding of the inventive concept, and the scope of the inventive concept is not limited thereto.

### Examples

### 1. Synthesis of (Meth)Acrylate Copolymer

In Synthetic Examples 1 to 10 below, the molecular weight measurement was performed using a Gel Permeation Chromatography (“GPC”) analysis device, HLC-8420GPC, manufactured by TOSOH Corporation. In this case, from a size exclusion chromatography (“SEC”) curve obtained by TSKgel SUPER HZM-N as a measurement column and a refractive index (“RI”) detector, the weight-average molecular weight (“Mw”) value obtained with a standard polystyrene (“PS”) conversion was selected.

Each composition ratio of the copolymer was calculated from the integral ratio of the signal belonging to each monomer component in the proton nuclear magnetic resonance (“NMR”) spectrum in the measurement with an NMR analyzer, AVANCE III 300M, manufactured by BRUKER. Also, deuterated chloroform (manufactured by KANTO CHEMICAL CO., INC.) was used as a deuterated solvent during the measurement.

### 1) Synthetic Example 1: Synthesis of MC-1

Butyl acetate (40 milliliter (mL)) was added to a round-bottom flask equipped with a cooling tube, a drip funnel, a nitrogen introduction tube, and a magnetic stirrer and was stirred at room temperature for about 30 minutes while nitrogen bubbling to perform the deoxidation of the solvent. This was heated in an oil bath until the internal temperature reached about 90° C., and then, 14.10 grams (g) of methyl methacrylate (MMA, manufactured by Tokyo Chemical Industry Co., Ltd.), 11.10 g of isobornyl methacrylate (IBXMA, manufactured by Tokyo Chemical Industry Co., Ltd.), and 6.33 g of 4-benzoylphenyl methacrylate (BPMA, manufactured by Tokyo Chemical Industry Co., Ltd.) as methacrylic acid monomers, 4.64 g of V-601 (manufactured by FUJIFILM Wako Pure Chemical Corporation) as a thermal polymerization initiator, and 10 mL of butyl acetate were made into a homogeneous solution in advance and added to the drip funnel, and the homogeneous solution in the drip funnel was slowly dropped into the flask for about 1 hour by opening the cock. Thereafter, the resulting mixture was stirred for about 1 hour to perform a polymerization reaction. After the reaction, the flask was taken out of the oil bath and fully cooled. Next, 800 mL of ethanol was added to the 1000 ml beaker and stirred with the magnetic stirrer, and the solution after the polymerization reaction in the flask was dropped thereto in relatively small portions to precipitate. The precipitate was filtered through a suction filtration, and was washing with ethanol and filtered again to remove butyl acetate and unreacted monomers. The precipitate was dried under reduced pressure to obtain 20.0 g of white powder (MC-1), which is a copolymer of MMA, IBXMA, and BPMA. The weight-average molecular weight of the white powder (MC-1) was about 5,700 g/mol, and the molecular weight distribution was about 1.39. The composition ratio of the copolymer was MMA:IBXMA:BPMA=65.7:21.4:13.0.

### 2) Synthetic Example 2: Synthesis of MC-2

The white powder (MC-2), which is a copolymer of MMA, IBXMA, and BPMA, was obtained in the same manner as in Synthetic Example 1, except that 11.0 g of MMA and 14.0 g of IBXMA were used. The yield was about 18.0 g, the weight-average molecular weight was about 4,600 g/mol, and the molecular weight distribution was about 1.40. The composition ratio of the copolymer was MMA:IBXMA:BPMA=48.0:39.0:13.0.

### 3) Synthetic Example 3: Synthesis of MC-3

The white powder (MC-3), which is a copolymer of MMA, IBXMA, and BPMA, was obtained in the same manner as in Synthetic Example 1, except that 1.55 g of V-601 was used. The yield was about 26.3 g, the weight-average molecular weight was about 18,900 g/mol, and the molecular weight distribution was about 1.31. The composition ratio of the copolymer was MMA:IBXMA:BPMA=62.1:24.4:13.5.

### 4) Synthetic Example 4: Synthesis of MC-4

The white powder (MC-4), which is a copolymer of MMA, IBXMA, and BPMA, was obtained in the same manner as in Synthetic Example 1, except that 0.52 g of V-601 was used. The yield was about 20.2 g, the weight-average molecular weight was about 47,900 g/mol, and the molecular weight distribution was about 2.05. The composition ratio of the copolymer was MMA:IBXMA:BPMA=63.3:22.1:14.6.

### 5) Synthetic Example 5: Synthesis of MC-5

The white powder (MC-5), which is a copolymer of MMA, IBXMA, and BPMA, was obtained in the same manner as in Synthetic Example 2, except that 23.0 g of V-601 was used. The yield was about 5.6 g, the weight-average molecular weight was about 1,300 g/mol, and the molecular weight distribution was about 1.20. The composition ratio of the copolymer was MMA:IBXMA:BPMA=40.0:43.3:16.7.

### 6) Synthetic Example 6: Synthesis of MC-6

The white powder (MC-6), which is a copolymer of MMA, IBXMA, and BPMA, was obtained in the same manner as in Synthetic Example 1, except that 0.39 g of V-601 was used. The yield was about 18.9 g, the weight-average molecular weight was about 53,200 g/mol, and the molecular weight distribution was about 1.99. The composition ratio of the copolymer was MMA:IBXMA:BPMA=63.7:21.6:14.7.

### 7) Synthetic Example 7: Synthesis of MC-7

The white powder (MC-7), which is a copolymer of MMA and IBXMA, was obtained in the same manner as in Synthetic Example 1, without adding BPMA. The yield was about 18.5 g, the weight-average molecular weight was about 4,200 g/mol, and the molecular weight distribution was about 1.52. The composition ratio of the copolymer was MMA:IBXMA=72.6:27.4.

### 8) Synthetic Example 8: Synthesis of MC-8

The white powder (MC-8), which is an MMA homopolymer, was obtained by performing the synthesis in the same manner as in Synthetic Example 1, except that IBXMA and BPMA were not added and 25.2 g of MMA and 2.21 g of V-601 were used. The yield was about 18.3 g, the weight-average molecular weight was about 6,100 g/mol, and the molecular weight distribution was about 1.56.

### 9) Synthetic Example 9: Synthesis of MC-9

The white powder (MC-9), which is an IBXMA homopolymer, was obtained by performing the synthesis in the same manner as in Synthetic Example 1, except that MMA and HEMA were not added and 25.1 g of IBXMA and 5.77 g of V-601 were used. The yield was about 8.80 g, the weight-average molecular weight was about 4,300 g/mol, and the molecular weight distribution was about 1.26.

### 10) Synthetic Example 10: Synthesis of MC-10

The white powder (MC-10), which is a BPMA homopolymer, was obtained by performing the synthesis in the same manner as in Synthetic Example 1, except that MMA and IBXMA were not added and 24.6 g of BPMA and 4.00 g of V-601 were used. The yield was about 22.6 g, the weight-average molecular weight was about 4,900 g/mol, and the molecular weight distribution was about 1.92.

### 2. Preparation of Resin Composition

Each of components listed in Tables 1 and 2 was mixed to prepare resin compositions of Examples and Comparative Examples. Each of components was provided to a light-shielding airtight container according to the mixing ratio listed in Tables 1 and 2. Thereafter, the resulting mixture was stirred at room temperature for about 12 hours by the mix rotor to prepare the resin compositions of Examples and Comparative Examples (unit: parts by weight).

TABLE 1

| | | Glass | Weight- | | | | | | | |
|---|---|---|---|---|---|---|---|---|---|---|
| | | transition | average | | | | | | | |
| | | temperature | molecular | Example | Example | Example | Example | Example | Comparative | Comparative |
| Component | Type | (Tg, ° C.) | weight | 1 | 2 | 3 | 4 | 5 | Example 1 | Example 2 |
| (Meth)acrylate | MC-1 | 101 | 5700 | 10 | | | | | | |
| copolymer | MC-2 | 117 | 4600 | | 10 | | | | | |
| | MC-3 | 116 | 18900 | | | 10 | | | | |
| | MC-4 | 118 | 47900 | | | | 5 | | | |
| | MC-5 | 102 | 1300 | | | | | 10 | | |
| | MC-6 | 117 | 53200 | | | | | | | |
| | MC-7 | 106 | 4200 | | | | | | | 10 |
| | MC-8 | 99 | 6100 | | | | | | | |
| | MC-9 | 151 | 4300 | | | | | | | |
| | MC-10 | 123 | 4800 | | | | | | | |
| Urethane | UF- | — | 32000 | 5 | 5 | 5 | 5 | 5 | 5 | 5 |
| (meth)acrylate | C051 | | | | | | | | | |
| oligomer | UN- | — | 13000 | 5 | 5 | 5 | 5 | 5 | 5 | 5 |
| | 6304 | | | | | | | | | |
| Monofunctional | 4HBA | — | — | 5 | 5 | 5 | 5 | 5 | 5 | 5 |
| (meth)acrylate | 2EHA | — | — | 85 | 85 | 85 | 85 | 85 | 85 | 85 |
| monomer | BPMA | — | — | | | | | | | |
| Photoinitiator | Omnirad | — | — | 3 | 3 | 3 | 3 | 3 | 3 | 3 |
| | 819 | | | | | | | | | |

TABLE 2

| | | Glass | Weight- | | | | | | |
|---|---|---|---|---|---|---|---|---|---|
| | | transition | average | | | | | | |
| | | temperature | molecular | Comparative | Comparative | Comparative | Comparative | Comparative | Comparative |
| Component | Type | (Tg, ° C.) | weight | Example 3 | Example 4 | Example 5 | Example 6 | Example 7 | Example 8 |
| (Meth)acrylate | MC-1 | 101 | 5700 | | | | | | |
| copolymer | MC-2 | 117 | 4600 | | | | | | |
| | MC-3 | 116 | 18900 | | | | | | |
| | MC-4 | 118 | 47900 | | | | | | |
| | MC-5 | 102 | 1300 | | | | | | |
| | MC-6 | 117 | 53200 | | 5 | 2 | | | |
| | MC-7 | 106 | 4200 | | | | | | |
| | MC-8 | 99 | 6100 | | | | 10 | | |
| | MC-9 | 151 | 4300 | | | | | 10 | |
| | MC-10 | 123 | 4800 | | | | | | 10 |
| Urethane | UF- | — | 32000 | 5 | 5 | 5 | 5 | 5 | 5 |
| (meth)acrylate | C051 | | | | | | | | |
| oligomer | UN- | — | 13000 | 5 | 5 | 5 | 5 | 5 | 5 |
| | 6304 | | | | | | | | |
| Monofunctional | 4HBA | — | | 5 | 5 | 5 | 5 | 5 | 5 |
| (meth)acrylate | 2EHA | — | | 85 | 85 | 85 | 85 | 85 | 85 |
| monomer | BPMA | — | | 10 | | | | | |
| Photoinitiator | Omnirad | — | | 3 | 3 | 3 | 3 | 3 | 3 |
| | 819 | | | | | | | | |

### <Materials in Tables 1 and 2>

MC-1: Copolymer of MMA, IBXMA and BPMA in Synthetic Example 1
MC-2: Copolymer of MMA, IBXMA and BPMA in Synthetic Example 2
MC-3: Copolymer of MMA, IBXMA and BPMA in Synthetic Example 3
MC-4: Copolymer of MMA, IBXMA and BPMA in Synthetic Example 4
MC-5: Copolymer of MMA, IBXMA and BPMA in Synthetic Example 5
MC-6: Copolymer of MMA, IBXMA and BPMA in Synthetic Example 6
MC-7: Copolymer of MMA and IBXMA in Synthetic Example 7
MC-8: MMA homopolymer in Synthetic Example 8
MC-9: IBXMA homopolymer in Synthetic Example 9
MC-10: BPMA homopolymer in Synthetic Example 10
UF-C051: Urethane acrylate oligomer (weight-average molecular weight of 32,000 g/mol) (manufactured by Kyoeisha Chemical Co., Ltd.)
UN-6304: Urethane acrylate oligomer (weight-average molecular weight of 13,000 g/mol) (manufactured by Negami Chemical Industrial Co., Ltd.)
2EHA: 2-Ethylhexyl acrylate (manufactured by TOAGOSEI Co., Ltd.)
4HBA: 4-Hydroxy butyl acrylate (manufactured by Osaka Organic Chemical Industry Ltd.)
Omnirad 819: Phenyl bis(2,4,6-trimethylbenzoyl)phosphine oxide (manufactured by IGM Resins, Inc.)

### 2. Evaluation of Resin Composition and Adhesive Member

The uniformity of the resin compositions of Examples and Comparative Examples, and the 180° peel strengths at about 25° C. and about 60° C. were evaluated and the results are shown in Table 3 below.

### <Uniformity of Resin Composition and Cured Product>

The uniformity of the prepared Example and Comparative Example compositions was confirmed with naked eyes, and the uniformity of the cured product after light irradiation of the prepared Example and Comparative Example compositions was confirmed with naked eyes, and evaluated according to the following evaluation criteria.
∘: Both the resin composition and the cured product after light irradiation are uniform
Δ: The resin composition is uniform, but the cured product after light irradiation is non-uniform (generation of insoluble matter/white turbidity, etc.)
x: The resin composition is non-uniform (generation of insoluble matter/white turbidity, etc.)

### <180° Peel Strength of Adhesive Member>

The prepared resin composition was applied onto a slide glass substrate having a size of about 76 mm×26 mm to have a thickness of about 50 μm. The applied resin composition was irradiated with the ultraviolet light so as to have a total amount of light of about 1,000 mJ/cm² by the UV-LED lamp having a peak at about 365 nm, thereby forming an adhesive member. Here, a PET film substrate having a size of about 150 mm×20 mm and a thickness of about 50 μm was bonded with an atmospheric pressure laminator, and the PET film substrate was pressed and defoamed in an autoclave under conditions of 30° C. and 0.5 MPa for 5 minutes to prepare a specimen for measuring peel strength.

According to K 6854, a 180° peel strength test was performed in temperature conditions of about 25° C. and about 60° C. The average value of the peel strength within the range of about 20 mm to about 80 mm from the start of peeling was selected as the evaluation value.

TABLE 3

| | Example | Example | Example | Example | Example |
|---|---|---|---|---|---|
| Division | 1 | 2 | 3 | 4 | 5 |
| Uniformity | ○ | ○ | ○ | ○ | ○ |
| Adhesiveness: | 880 | 900 | 1400 | 1000 | 800 |
| 25° C. | | | | | |
| peel strength | | | | | |
| [gf/25 mm] | | | | | |
| Adhesiveness: | 250 | 200 | 320 | 280 | 200 |
| 60° C. | | | | | |
| peel strength | | | | | |
| [gf/25 mm] | | | | | |

TABLE 4

| | Comparative | Comparative | Comparative | Comparative | Comparative | Comparative | Comparative | Comparative |
|---|---|---|---|---|---|---|---|---|
| Division | Example 1 | Example 2 | Example 3 | Example 4 | Example 5 | Example 6 | Example 7 | Example 8 |
| Uniformity | ∘ | ∘ | ∘ | x | ∘ | ∘ | Δ | x |
| Adhesiveness: | 50 | 880 | 80 | — | 790 | 240 | 80 | — |
| 25° C. | | | | | | | | |
| peel strength | | | | | | | | |
| [gf/25 mm] | | | | | | | | |
| Adhesiveness: | 20 | 20 | 20 | — | 60 | 20 | 20 | — |
| 60° C. | | | | | | | | |
| peel strength | | | | | | | | |
| [gf/25 mm] | | | | | | | | |

Referring to Tables 3 and 4, it may be seen that the resin compositions of Examples 1 to 5 including the (meth)acrylate copolymer (hereinafter, also referred to as a copolymer) of an embodiment synthesized in Synthetic Examples 1 to 5 exhibited excellent adhesiveness at both room temperature (about 25° C.) and a relatively high temperature (about 60° C.) from the measurement results of the specimen for measuring peel strength, the specimen being prepared by light irradiation once in the atmosphere including oxygen. This result is considered to be due to the formation of a cross-linking structure with the matrix in the resin composition through the hydrogen withdrawing reaction by the benzophenone structure in the copolymer while segregating the copolymer of an embodiment to the outermost side of the adhesive member when the resin composition is cured, thereby ensuring adhesiveness by constant cohesive force. It was difficult to obtain a copolymer having a weight-average molecular weight below the weight-average molecular weight of the copolymer according to Synthetic Example 5. Specifically, since the copolymer having a weight-average molecular weight less than about 1,000 g/mol does not become a solid form, it is difficult to perform the purification and isolation in terms of phase states and purity.

Comparative Example 1 showed a result of significantly deteriorating adhesiveness at room temperature as well as at a relatively high temperature by the resin composition which does not include the copolymer according to the inventive concept. This result is because the curing inhibition phenomenon occurred on the outermost surface of the adhesive member due to the influence of oxygen in the atmosphere.

Comparative Example 2 used a resin composition including a copolymer (MMA/IBXMA) which does not have the benzophenone structure, and exhibited adhesiveness at room temperature similar to those of Examples according to the inventive concept, but at a relatively high temperature (about 60° C.), the adhesiveness was significantly deteriorated compared to Examples. This result is considered to be due to the fact that, at about room temperature, constant adhesiveness may be ensured for the same reason as the copolymer according to the inventive concept, but since crosslinking with the resin composition does not occur, fluidity is extremely relatively high at a relatively high temperature, and cohesive force of the whole is lost.

It may be seen that since the effect of the crosslinking structure due to the hydrogen withdrawing reaction is equalized, like the resin composition used in Comparative Example 3, only including a monomer of BPMA instead of the copolymer according to the inventive concept is not enough to secure the desired peel strength.

Comparative Examples 4 and 5 are results of using the copolymer having a weight-average molecular weight of about 50,000 g/mol or more in the resin composition. In Comparative Examples 4 and 5, the solubility was reduced as the weight-average molecular weight of the copolymer contained in the resin composition was increased. Specifically, like the resin composition used in Comparative Example 4, when the copolymer was contained in an amount of 5 parts by weight, the copolymer was not dissolved. As in Comparative Example 5, when the copolymer was contained in an amount of 2 parts by weight, the copolymer was dissolved, but the amount of the copolymer added is small, and thus sufficient adhesiveness was not exhibited.

The evaluation was performed by respectively adding homopolymers of monomers to the resin compositions used in Comparative Examples 6 to 8. The MMA homopolymer had excellent compatibility but did not exhibit a peel strength (Comparative Example 6), the IBXMA homopolymer exhibited a result of the segregation after cured (Comparative Example 7), and when the BPMA homopolymer was used, there exhibited the results in that the adhesiveness significantly deteriorated so that the peel strength was not measured at room temperature and a relatively high temperature, and the compatibility of the resin composition is insufficient (Comparative Example 8).

The resin composition of an embodiment may provide properties which may inhibit the phenomenon in which the surface curing is deteriorated due to oxygen in the air during photo-curing. Accordingly, the adhesive member formed from the resin composition of an embodiment may exhibit excellent adhesiveness not only at room temperature but also at a relatively high temperature.

The adhesive member of an embodiment has excellent peel strength, and thus the display device including the same may exhibit excellent adhesive reliability.

In addition, according to the method of manufacturing a display device of an embodiment, the adhesive member may be prepared through a single light irradiation in the atmosphere, and thus an additional increase in process and equipment is not desired, so that production efficiency may be improved and manufacturing costs may be reduced.

Although the inventive concept has been described with reference to a preferred embodiment of the inventive concept, it will be understood that the inventive concept should not be limited to these preferred embodiments but various changes and modifications may be made by those skilled in the art without departing from the spirit and scope of the inventive concept.

Accordingly, the technical scope of the inventive concept is not intended to be limited to the contents set forth in the detailed description of the specification, but is intended to be defined by the appended claims.

What is claimed is:

1. A resin composition comprising:
a (meth)acrylate copolymer polymerized including first to third monomers;
a urethane (meth)acrylate oligomer;
a monofunctional (meth)acrylate monomer; and
a photoinitiator,
wherein the (meth)acrylate copolymer has a weight-average molecular weight equal to or greater than about 1,000 grams per mole and less than 50,000 grams per mole,
wherein
the first monomer is represented by Formula 1 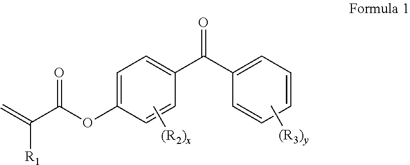
wherein, in Formula 1,
R₁ is a hydrogen atom or a methyl group,
R₂ and R₃ are each independently a hydrogen atom, an unsubstituted alkyl group having 1 to 18 carbon atoms, an unsubstituted alkoxy group having 1 to 12 carbon atoms, a hydroxyl group, a carboxyl group, or a halogen atom,
x is an integer of 0 to 4, and
y is an integer of 0 to 5,
the second monomer comprises at least one of an alkyl (meth)acrylate, a hydroxyalkyl (meth)acrylate, or an alkoxyalkyl (meth)acrylate, and
the third monomer is an aliphatic cyclic (meth)acrylate.

2. The resin composition of claim 1, wherein, with respect to 100 parts by weight of the urethane (meth)acrylate oligomer, the monofunctional (meth)acrylate monomer, and the photoinitiator, the (meth)acrylate copolymer is included in an amount of about 0.1 parts by weight to about 50 parts by weight.

3. The resin composition of claim 1, wherein the (meth)acrylate copolymer comprises about 1 mole percent to about 50 mole percent of the first monomer in a polymerized form.

4. The resin composition of claim 1, wherein the urethane (meth)acrylate oligomer has a weight-average molecular weight of about 5,000 grams per mole to about 100,000 grams per mole.

5. The resin composition of claim 1, wherein the resin composition has a peel strength of about 400 grams-force per 25 millimeters or more at about 25 degrees Celsius according to Japanese Industrial Standard K6854 after photo-cured.

6. The resin composition of claim 1, wherein the resin composition has a peel strength of about 100 grams-force per 25 millimeters or more at about 60 degrees Celsius according to Japanese Industrial Standard K6854 after photo-cured.

7. The resin composition of claim 1, wherein the resin composition does not comprise an organic solvent.

8. The resin composition of claim 1, wherein the (meth)acrylate copolymer has a glass transition temperature of about 100 degrees Celsius or higher.

9. The resin composition of claim 1, wherein the first monomer is a 4-benzoylphenyl methacrylate.

10. A method of manufacturing a display device comprising:
providing a resin composition on a first substrate;
irradiating the resin composition with ultraviolet light in an atmosphere to form an adhesive member; and
providing a second substrate on the adhesive member,
wherein the resin composition comprises
a (meth)acrylate copolymer polymerized including first to third monomers;
a urethane (meth)acrylate oligomer;
a monofunctional (meth)acrylate monomer; and
a photoinitiator,
wherein
the first monomer is represented by Formula 1 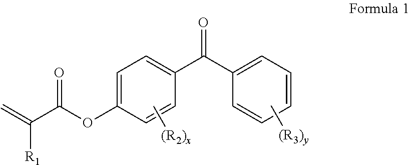
wherein, in Formula 1,
R₁ is a hydrogen atom or a methyl group,
R₂ and R₃ are each independently a hydrogen atom, an unsubstituted alkyl group having 1 to 18 carbon atoms, an unsubstituted alkoxy group having 1 to 12 carbon atoms, a hydroxyl group, a carboxyl group, or a halogen atom,
x is an integer of 0 to 4, and
y is an integer of 0 to 5,
the second monomer comprises at least one of an alkyl (meth)acrylate, a hydroxyalkyl (meth)acrylate, or an alkoxyalkyl (meth)acrylate, and
the third monomer is an aliphatic cyclic (meth)acrylate.

11. The method of claim 10, wherein the (meth)acrylate copolymer has a weight-average molecular weight equal to or greater than about 1,000 grams per mole and less than 50,000 grams per mole.

12. The method of claim 10, wherein the adhesive member has a peel strength of about 400 grams-force per 25 millimeters or more at about 25 degrees Celsius according to Japanese Industrial Standard K6854 and about 100 grams-force per 25 millimeters or more at about 60 degrees Celsius.

13. The method of claim 10, wherein the resin composition does not comprise an organic solvent.

14. A display device comprising:
a display panel;
a window disposed on the display panel; and
an adhesive member which is disposed between the display panel and the window and comprises a polymer derived from a resin composition comprising a (meth)acrylate copolymer polymerized including first to third monomers, a urethane (meth)acrylate oligomer, a monofunctional (meth)acrylate monomer, and a photoinitiator,
wherein the (meth)acrylate copolymer has a weight-average molecular weight equal to or greater than about 1,000 grams per mole and less than 50,000 grams per mole,
the first monomer is represented by Formula 1, 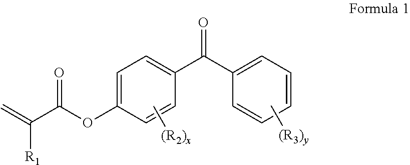
wherein, in Formula 1,
R₁ is a hydrogen atom or a methyl group,
R₂ and R₃ are each independently a hydrogen atom, an unsubstituted alkyl group having 1 to 18 carbon atoms, an unsubstituted alkoxy group having 1 to 12 carbon atoms, a hydroxyl group, a carboxyl group, or a halogen atom,
x is an integer of 0 to 4, and
y is an integer of 0 to 5,
the second monomer comprises at least one of an alkyl (meth)acrylate, a hydroxyalkyl (meth)acrylate, or an alkoxyalkyl (meth)acrylate, and
the third monomer is an aliphatic cyclic (meth)acrylate.

15. The display device of claim 14, wherein, with respect to 100 parts by weight of the urethane (meth)acrylate oligomer, the monofunctional (meth)acrylate monomer, and the photoinitiator, the (meth)acrylate copolymer is included in an amount of about 0.1 parts by weight to about 50 parts by weight.

16. The display device of claim 14, wherein the (meth)acrylate copolymer comprises about 1 mole percent to about 50 mole percent of the first monomer in a polymerized form.

17. The display device of claim 14, wherein the urethane (meth)acrylate oligomer has a weight-average molecular weight of about 5,000 grams per mole to about 100,000 grams per mole.

18. The display device of claim 14, wherein the adhesive member has a peel strength of about 400 grams-force per 25 millimeters or more at about 25 degrees Celsius according to Japanese Industrial Standard K6854.

19. The display device of claim 14, wherein the adhesive member has a peel strength of about 100 grams-force per 25 millimeters or more at about 60 degrees Celsius according to Japanese Industrial Standard K6854.

20. The display device of claim 14, wherein the adhesive member has a thickness of about 50 micrometers to about 200 micrometers.
